(19) United States
(12) Patent Application Publication
(10) Pub. No.: US 2026/0335688 A1
(43) Pub. Date: Oct. 29, 2026

(54) DESCENT DEVICE

(71) Applicant: DONUT SAFETY SYSTEMS LIMITED, Stockport Cheshire (GB)

(72) Inventor: Stephen GRIFFITHS, St Asaph, Gwynedd (GB)

(21) Appl. No.: 19/101,654

(22) PCT Filed: Sep. 1, 2023
(86) PCT No.: PCT/EP2023/074096

§ 371 Date: Feb. 6, 2025

(30) Foreign Application Priority Data
Sep. 2, 2022 (GB) 2212793.0

(51) Int. Cl. A62B 1/14; F16D 63/00

(52) U.S. Cl. CPC A62B 1/14; F16D 63/008

(57) ABSTRACT

There is provided a descent device comprising a body for attachment to a load, such as a person, and a series of apertures extending through the body for passage of a line in alternate directions therethrough, from a first aperture to a final aperture, such that regions of the body delimiting and extending between the apertures provide a discontinuous contact surface for frictional engagement with the line. The series of apertures comprises a first group of apertures providing a first frictional resistance and including the first aperture, and a second group of apertures providing a second frictional resistance greater than the first frictional resistance and including the final aperture. The device may have application as an emergency descent device, such as to allow a person to descend from one position to another to escape a dangerous environment.

### TECHNICAL FIELD

The invention relates to a descent device. Particularly, though not exclusively, the invention relates to an descent device for emergency use, such as to allow a person to descend from one position to another to escape a dangerous environment.

### BACKGROUND

Descent devices (sometimes referred to descender devices or descending devices) may be used as part of a descent system, including a descent line and other equipment, such as a harness and an anchor, to allow a person to descend from one position to another. There are different types of descent devices intended for different purposes, including recreational use and emergency use. For emergency use, descent devices may be used, for example, to permit rapid escape of personnel from a dangerous environment at an upper storey of a building or other elevated location, including offshore oil and gas platforms, floating production storage and offloading (FPSO) units, drilling rigs and ships.

Descent devices may be automatic (type 1 as defined by European Standard EN 341:2011) or manually operated (type 2 as defined by EN 341:2011). Automatic descent devices are intended for when a user does not need to control the descent speed, and the descent speed is therefore controlled automatically, i.e. without a need for intervention by the user. Manual descent devices are for when the user may need to control the descent speed, including the need to stop at a position along the descent line. However, manual descent devices, particularly those for emergency use, may have at least some degree of automatic control to allow for their safe use without intervention by the user.

FIG. 1 shows a descent system 10 disclosed in earlier patent application WO 90/04998. The system 10 comprises a harness 12 attached to a descent device 14 (restrainer member), through which may pass, at a controlled rate, a line 16 of sufficient length to enable a user to descend from one position to another. The descent device 14 is in the form of a disc-shaped plate defining a series of parallel elongate slots through which the line 16 passes alternately in opposite directions. The descent device 14 incorporates a large aperture 20 that may serve as a hand grip, and near the base of the device 14 its thickness is increased to provide a further aperture to receive the shaft of a quick-release shackle 24. The line 16 is stored and paid out from a bag 26, and has a fixing hook 28 at its free end.

When the system 10 is required for use, the hook 28 is secured to a fixed point. A user puts on the harness 12, and the line 16 may be pulled through the descent device 14 to provide a sufficient free amount of the line 16 above the device 14 for the user to put on the harness 12. Once freely suspended on the device 14, the user may control the rate of descent by paying-out the line 16 from the bag 26, or simply allow it to pay-out at a controlled rate determined by the bag 26. At any time, the descent may be slowed by the user applying a hold on the lower section of the line 16, i.e. the section of line 16 yet to enter the device 14. If it is required to stop the descent, and lock-off the device 14 to prevent further descent, the user may loop the lower section of the line 16 over the device 14 such that the lower section of line 16 becomes trapped between the device 14 and the upper section of the line 16, i.e. the section of line 16 that has exited the device 14.

It is desirable to provide a descent device capable of maintaining a continuous descent at a desired maximum descent speed, for example 2 m/s (as required by EN 341:2011), and particularly a manually operated descent device capable of maintaining a continuous descent speed without intervention by a user. Moreover, it is desirable to provide a descent device capable of maintaining a desired descent speed for a range of loads, and/or over a range conditions, such as wet/dry conditions and hot/cold conditions.

It is an object of embodiments of the invention to provide an improved descent device, for example that is capable of maintaining a continuous descent speed as described above, and/or at least mitigate one or more problems that are associated with known arrangements.

### SUMMARY OF THE INVENTION

According to an aspect of the invention, there is provided a descent device comprising: a body for attachment to a load; and a series of apertures extending through the body for passage of a line in alternate directions therethrough, from a first aperture to a final aperture, such that regions of the body delimiting and extending between the apertures provide a discontinuous contact surface for frictional engagement with the line, wherein the series of apertures comprises a first group of apertures providing a first frictional resistance and including the first aperture, and a second group of apertures providing a second frictional resistance greater than the first frictional resistance and including the final aperture. Generally, the first group of apertures may provide a base amount of frictional resistance and function primarily as a guide, and the second group of apertures may provide a relatively higher amount of frictional resistance dependent upon the load and function primarily as brake. The device may be for emergency use, such as to allow a person to descend from one position to another to escape a dangerous environment. In particular, the device may be operated without user intervention, allowing a person to descend from one position to another at a controlled speed of descent, over a range of loads.

In certain embodiments, the first group of apertures may comprise one or more apertures having a first height less than a height of one or more of the remaining apertures of the first group of apertures. The one or more apertures having the first height may include the first aperture, and in certain embodiments may include the first aperture only. Additionally, or alternatively, the second group of apertures may comprise one or more apertures having a second height less than a height of one or more of the remaining apertures of the second group of apertures (the height of the one or more of the remaining apertures of the second group of apertures may be the same as or different to the height of the one or more of the remaining apertures of the first group of apertures). The one or more apertures having the second height may include the final aperture and one other aperture, and in certain embodiments may include the final aperture and one other aperture and only. The first height may be equal to the second height and/or each aperture of the series of apertures may have a height other than the first or second heights has a third height. The body may be substantially planar.

In certain embodiments, the first group of apertures may be spaced from one another by a first spacing and the second group of apertures are spaced from one another by a second spacing greater than the first spacing. The first group of apertures and the second group of apertures may be spaced from one another by the first spacing. Additionally, or alternatively, the series of elongate apertures may comprise five apertures, the first group of apertures comprising three apertures and the second group of apertures comprising two apertures. In certain embodiments, the series of elongate apertures may consist of six apertures, the first group of apertures consisting of three apertures and the second group of apertures consisting of three apertures. In certain embodiments, one or more of the apertures may comprise a rounded or chamfered edge extending about a periphery thereof on a first side of the body and/or on an opposing second side of the body. The apertures of the series of apertures may be a series of parallel elongate slots. One or more of the slots of the series of parallel elongate slots may have a first width.

In certain embodiments, the device comprises a line passing in alternate directions through the series of apertures, i.e. from the first aperture to the final aperture. The line may have a thickness that is at least 50% of the first height and/or the second height. The line may have a width approximately equal to the first width. The line may comprise a length of woven flat webbing or woven tubular webbing.

In certain embodiments, the first height and/or the second height may be approximately 4 mm (for example, 4 mm+/−0.5 mm) and the thickness of the line is approximately 2 mm (for example, 2 mm+/−0.5 mm). Additionally, or alternatively, the first spacing may be approximately 9 mm (for example, 9 mm+/−2 mm) and the second spacing may be approximately 11 mm (for example, 11 mm+/−2 mm).

In certain embodiments, the device may comprise a further aperture (i.e. a connection aperture) extending through the body to attach a load thereto, including an aperture for connecting a quick-release shackle, or similar, to the body. Additionally, or alternatively, the device may comprise a further aperture (i.e. a handle aperture) extending through the body to provide a handle.

### BRIEF DESCRIPTION OF THE DRAWINGS

Embodiments of the invention will be described, by way of example only, with reference to the accompanying figures, in which:

FIG. 1 is a perspective view of a descent system according to the prior art, including a descent device according to the prior art;

FIG. 2 is a front view of a descent device according to an embodiment of the invention, the device comprising first and second groups of apertures;

FIG. 3 is a cross-sectional view of the descent device of FIG. 2 taken through the centre of the apertures; and

FIG. 4 is an enlarged partial view of the descent device of FIG. 2 denoting heights of and spacings between the apertures.

### DETAILED DESCRIPTION OF EMBODIMENTS OF THE INVENTION

Embodiments of the invention may have application as an automatic or a manually controlled descent device, and may have particular application for emergency use to allow a person to descend from one position to another to escape a dangerous environment. Embodiments of the invention may be controlled by a user, or a third party to lower the user, for example a casualty, or other load in a controlled manner. However, embodiments of the invention may also be operated without user or third party intervention, safeguarding a user who may be injured or unconscious, and thus unable to control the speed of descent, minimising the possibility of further injury by impacting the ground or other surface at an uncontrolled speed.

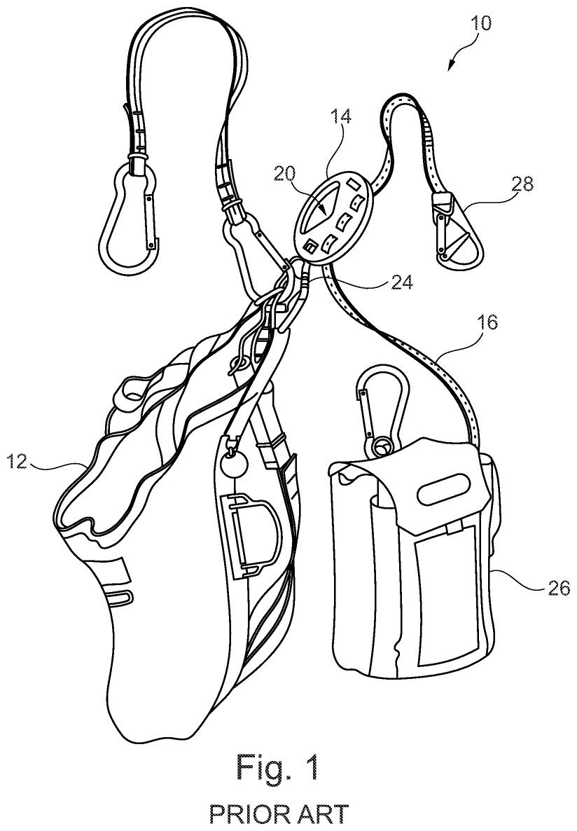

Embodiments of the invention may be for single use, and/or may be simple and inexpensive to manufacture. Embodiments of the invention may replace the descent device 14, or the descent device 14 and the line 16, in the prior art arrangement of FIG. 1. Embodiments of the invention may therefore be for use in new descent systems and/or to retro fit existing descent systems.

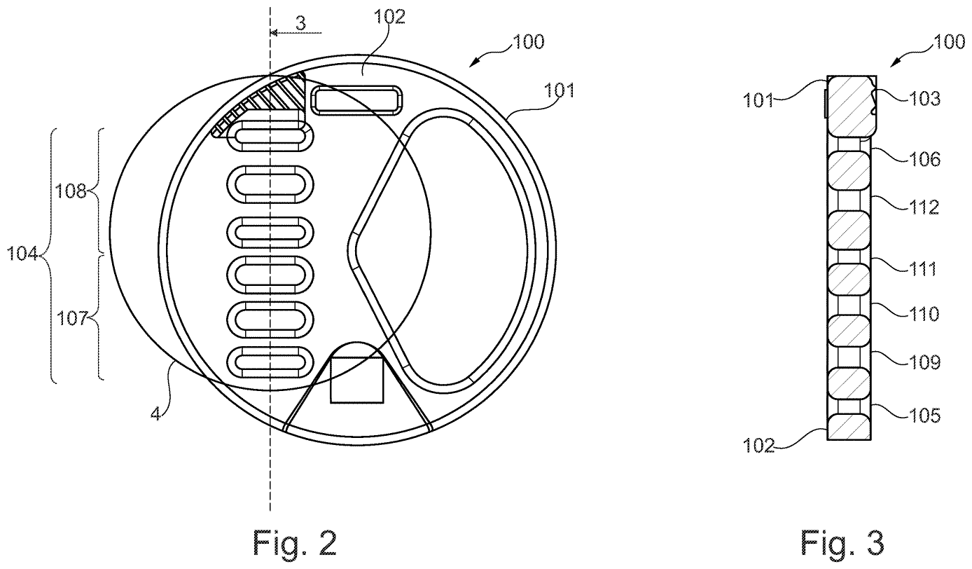

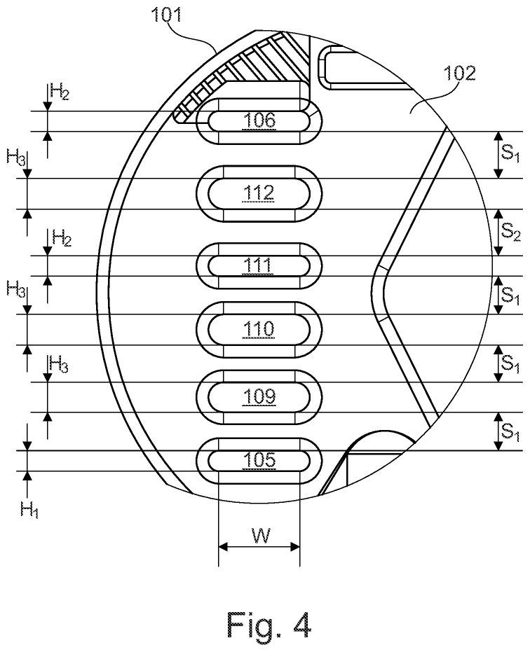

FIGS. 2, 3 and 4 show a descent device 100 according to an embodiment of the invention. The device 100 comprises a substantially planar disc-shaped body 101 having a first side 102 and an opposing second side 103, and further comprises a series of apertures 104 extending through the body 101. In the illustrated embodiment, the apertures 104 are provided as a series of parallel elongate slots. The apertures 104 are arranged from a first aperture 105 to a final aperture 106 such that a descent line can pass in alternate directions through the body 101, the line first entering the body 101 by passing through the first aperture 105 and finally exiting the body 101 by passing through the final aperture 106. As the line passes through the apertures 104 it contacts regions of the body 101 that delimit and extend between the apertures 104. These regions provide the body 101 with a discontinuous contact surface that frictionally engages the line.

As the skilled reader will understand, the above-described frictional engagement of the body 101 and the line will result in frictional resistance that slows passage of the line through the body 101, i.e. through the apertures 104, and thereby determines the descent speed of the device 100 for a given load. Frictional resistance is calculated by multiplying the normal force by the coefficient of friction (more total normal force equals more friction). As such, the total frictional resistance exhibited by the device 100 is proportional to the sum of the angles that the line bends around as it passes through the body 101.

The series of apertures 104 comprises a first group 107 of apertures and a second group 108 of apertures. The apertures of the first group 107 are arranged such that the line passes through each consecutively, and are configured to provide collectively a first frictional resistance to slow passage of the line through the body 101. Similarly, the apertures of the second group 108 are arranged such that the line passes through each consecutively, and are configured to provide collectively a second frictional resistance to slow passage of the line through the body 101. In use, the line first passes through the first group 107 and subsequently through the second group 108.

It has been found that by making the second frictional resistance greater than the first frictional resistance the device 100 may exhibit improved control of descent. In particular, the device 100 may maintain a continuous descent at a desired maximum descent speed over a range of loads, including descent speeds not exceeding 2 m/s over an range of loads from 50 kg to 150 kg. The frictional resistance of each group 107, 108 may be varied by adjusting the height of one or more of the apertures thereof. Used herein, the height of an aperture is the dimension parallel to the general direction in which the line passes through the body 101. Decreasing the height of an aperture increases the pitch of the line as it passes therethrough, which causes an increase in normal force acting on the contact surface and a resulting increase in frictional resistance.

In the illustrated embodiment, the first group 107 of apertures comprises three apertures: the first aperture 105, a second aperture 109 and a third aperture 110. The second group 108 of apertures also comprises three apertures: a fourth aperture 111, a fifth aperture 112 and the final aperture 106. The first group 107 comprises a single aperture (e.g. the first aperture 105) having a first height H₁ that is less than a height of the remaining apertures of the first group 107. The second group 108 of apertures comprises two apertures (e.g. the fourth aperture 111 and the final aperture 106) having a second height H₂ that is less than a height of the remaining apertures of the second group 108. The first and second heights H₁, H₂ are equal to one another, and the height of the remaining apertures of the first and second groups 107, 108 is a third height H₃.

By virtue of the above-described arrangement, the sum of the normal forces resulting from passage of the line through the apertures of the second group 108 is greater than that of the first group 107. Consequently, the second group 108 is responsible for the majority of the frictional resistance exhibited by the device 100 and, crucially, the magnitude of frictional resistance of the second group 108 is more variable with varying load, i.e. the second group 108 is more sensitive to changes in load applied to the device in use, compared to the first group 107. The first group 107 thereby provides a relatively lower, base level of frictional resistance and functions primarily as a guide to stabilise and feed the line to the second group 108, which provides a relatively higher frictional resistance dependent upon the load and functions primarily as brake.

The first aperture 105, although having the first height H₁, does not necessarily contribute to the frictional resistance as much as each of the fourth aperture 111 and the final aperture 106, each having the second height H₂ being the same as the first height H₁, since the line will be under less tension as it enters the first aperture 105. The height of the first aperture 105 may be less than the height of the remaining apertures of the first group 107 to provide improved control of descent by the user applying a hold on the line before it enters the body 101, i.e. to make the first aperture 105 more sensitive to a change in angle that the user holds the line relative to the body 101.

It has also been found that the frictional resistance of each group 107, 108 may be varied by adjusting the spacing between adjacent apertures, particularly when the line is provided in the form of woven tubular webbing. In the illustrated embodiment, the first group 107 of apertures are spaced from one another by a first spacing S₁ and the second group 108 of apertures are spaced from one another by a second spacing S₂. Moreover, the first group 107 of apertures and the second group 108 of apertures (i.e. the third aperture 110 and the fourth aperture 111) are spaced from one another by the first spacing S₁. The second spacing S₂ is greater than the first spacing S₁l , thereby increasing the frictional resistance of the second group 108 relative to the first group 107.

While any suitable configuration of apertures may be used, the series of apertures 104 of the illustrated embodiment has been found to be particularly suitable. The first height H₁ and the second height H₂ may be approximately 4 mm, and the third height H₃ may be approximately 6 mm. The first spacing S₁ may be approximately 9 mm and the second spacing S₂ maybe approximately 11 mm. The thickness of the body 101 maybe approximately 12 mm. Each of the series of apertures 104 may comprise a rounded or chamfered edge 113 extending about a periphery thereof on each of the first and second sides 102, 103, including a rounded edge have a radius of approximately 3 mm. Each of the series of apertures 104 may have a width W₁ of approximately 18 mm.

Similarly, any suitable line may be used, though a line having thickness that is approximately 50% of the first and second heights H₁, H₂, for example a thickness of approximately 2 mm has been found to be particularly suitable. The line may have a width that is substantially equal to the width W₁ of the apertures 104, or at least within 2 mm thereof.

A lightweight metallic alloy is preferred for the body 101, such as an aluminium alloy. However, the body 101 may be produced from a rigid plastics material with metallic inserts around the apertures 104 to facilitates the dissipation of heat generated by the frictional engagement with the line, and to prevent excessive wear. The line may be provided in the form of woven webbing, including woven tubular webbing and woven flat webbing, and may be may be made from any suitable material. Particularly suitable materials for the line include nylon and polyester.

The descent device 100 may be for use in a descent system, such as the descent system 10 shown in FIG. 1.

The invention is not restricted to the details of any foregoing embodiments. For example, while in the illustrated embodiment, the apertures 104 are provided as a series parallel elongate slots, other shaped apertures are contemplated, including circular or square apertures. The exact number, spacing, sizes, and shape of the apertures 104 may be determined for particular applications. The size and shape of the body 101 may be any suitable size and shape, so the first height H₁ need not equal the second height H₂. The device 100 may further comprise additional features, for example a further aperture 114 providing a handle for a user to hold, and a further aperture 115 for connecting to a shackle, or similar, i.e. means to attach a load to the body 101. The apertures 104 may be offset from the centreline of the device, as shown in the illustrated embodiment, or may be aligned the centreline and/or the further aperture 115 for attachment of a load to the body 101.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

Attention is directed to all papers and documents which are filed concurrently with or previous to this specification in connection with this application and which are open to public inspection with this specification, and the contents of all such papers and documents are incorporated herein by reference.

1. A descent device comprising:
a body for attachment to a load; and
a series of apertures extending through the body for passage of a line in alternate directions therethrough, from a first aperture to a final aperture, such that regions of the body delimiting and extending between the apertures provide a discontinuous contact surface for frictional engagement with the line,
wherein the series of apertures comprises a first group of apertures providing a first frictional resistance and including the first aperture, and a second group of apertures providing a second frictional resistance greater than the first frictional resistance and including the final aperture.

2. A descent device according to claim 1, wherein the first group of apertures comprises one or more apertures having a first height less than a height of one or more of the remaining apertures of the first group of apertures.

3. A descent device according to claim 2, wherein the one or more apertures having the first height includes the first aperture.

4. A descent device according to claim 1 wherein the second group of apertures comprises one or more apertures having a second height less than a height of one or more of the remaining apertures of the second group of apertures.

5. A descent device according to claim 4, wherein the one or more apertures having the second height includes the final aperture and one other aperture.

6. A descent device according to claim 4, wherein the first height equals the second height.

7. A descent device according to claim 2, wherein each aperture of the series of apertures having a height other than the first or second heights has a third height.

8. A descent device according to claim 1, wherein the first group of apertures are spaced from one another by a first spacing and the second group of apertures are spaced from one another by a second spacing greater than the first spacing.

9. A descent device according to claim 8, wherein the first group of apertures and the second group of apertures are spaced from one another by the first spacing.

10. A descent device according to claim 1, wherein the series of elongate apertures comprises five apertures, the first group of apertures comprising three apertures and the second group of apertures comprising two apertures.

11. A descent device according to claim 1, wherein the series of elongate apertures consists of six apertures, the first group of apertures consisting of three apertures and the second group of apertures consisting of three apertures.

12. A descent device according to claim 1, wherein one or more of the apertures comprises a rounded or chamfered edge extending about a periphery thereof on a first side of the body and/or on an opposing second side of the body.

13. A descent device according to claim 1, wherein apertures of the series of apertures are a series of parallel elongate slots.

14. A descent device according to claim 13, wherein one or more of the slots of the series of parallel elongate slots has a first width.

15. A descent device according to claim 1, wherein the device comprises a line passing in alternate directions through the series of apertures.

16. A descent device according to claim 15, wherein the line has a thickness that is at least 50% of the first height and/or the second height.

17. A descent device according to claim 15, where the line has width approximately equal to the first width.

18. A descent device according to claim 15, wherein the line comprises a length of woven flat webbing or woven tubular webbing.

19. A descent device according to claim 15, wherein the first height and/or the second height is approximately 4 mm and the thickness of the line is approximately 2 mm.

20. A descent device according to claim 8, wherein the first spacing is approximately 9 mm and the second spacing is approximately 11 mm.
